(19) United States
(12) Patent Application Publication
(10) Pub. No.: US 2025/0156386 A1
(43) Pub. Date: May 15, 2025

(54) Technologies for Managing Data Duplication in a Multithreaded Environment

(71) Applicant: The PNC Financial Services Group, Inc., Pittsburgh, PA (US)

(72) Inventors: Datta Gopal Suryawanshi, Middleburg Heights, OH (US); Gaurav Chopra, North Royalton, OH (US)

(21) Appl. No.: 18/939,748

(22) Filed: Nov. 7, 2024

Related U.S. Application Data
(60) Provisional application No. 63/597,709, filed on Nov. 10, 2023.

(51) Int. Cl. G06F 16/215

(52) U.S. Cl. CPC G06F 16/215

(57) ABSTRACT

Technologies for managing data duplication in a multithreaded environment include a compute device. The compute device includes circuitry configured to receive a request to write, to a primary table of a database, a data set pertaining to a property of an entity. The circuitry is also configured to construct, based on the data set, an index to determine whether a record pertaining to the property of the entity is present in the database, determine, using the constructed index, whether an existing record pertaining to the property of the entity is present in a secondary table designated to contain temporary records associated with write requests from a predefined period, and perform, in response to a determination that an existing record pertaining to the property of the entity is present in the secondary table, a corrective action to remediate concurrent writes to the database pertaining to the property of the entity.

### RELATED APPLICATIONS

This application claims the benefit of U.S. Provisional Application Ser. No. 63/597,709 filed Nov. 10, 2023 for “Technologies for Managing Data Duplication in a Multithreaded Environment,” which is hereby incorporated by reference in its entirety.

### BACKGROUND

For large institutions (e.g., financial institutions, product manufacturers, product distributors, retailers, etc.) with operations spanning various geographic locations, compute devices in those locations may carry out sets of tasks (e.g., threads) in furtherance of the goals of the institution. In doing so, the compute devices may access a central database to receive and send data updates. In many cases, though occurring in physically separate locations, the operations may be of a similar nature. As such, compute devices executing separate threads may produce data that pertains to the same data set in the central database and may attempt to write the data (e.g., through a corresponding write request) to the central database contemporaneously (e.g., at the same time, separated by milliseconds, or separated by a small enough time delay that a write request associated with one thread (e.g., executed by one compute device) is received before a preceding write request associated with another thread (e.g., executed by another compute device) has been processed and committed to the central database). As such, situations may arise in which multiple data writes pertaining to the same record or type of data may occur and cause conflicts or duplicates in the central database, resulting in confusion and processing delays for any subsequent reads to the affected data (e.g., by downstream compute devices).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for managing data duplication in a multithreaded environment;

FIG. 2 is a simplified block diagram of at least one embodiment of a compute device of the system of FIG. 1; and

FIGS. 3-6 are simplified block diagrams of at least one embodiment of a method for managing data duplication in a multithreaded environment that may be performed by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

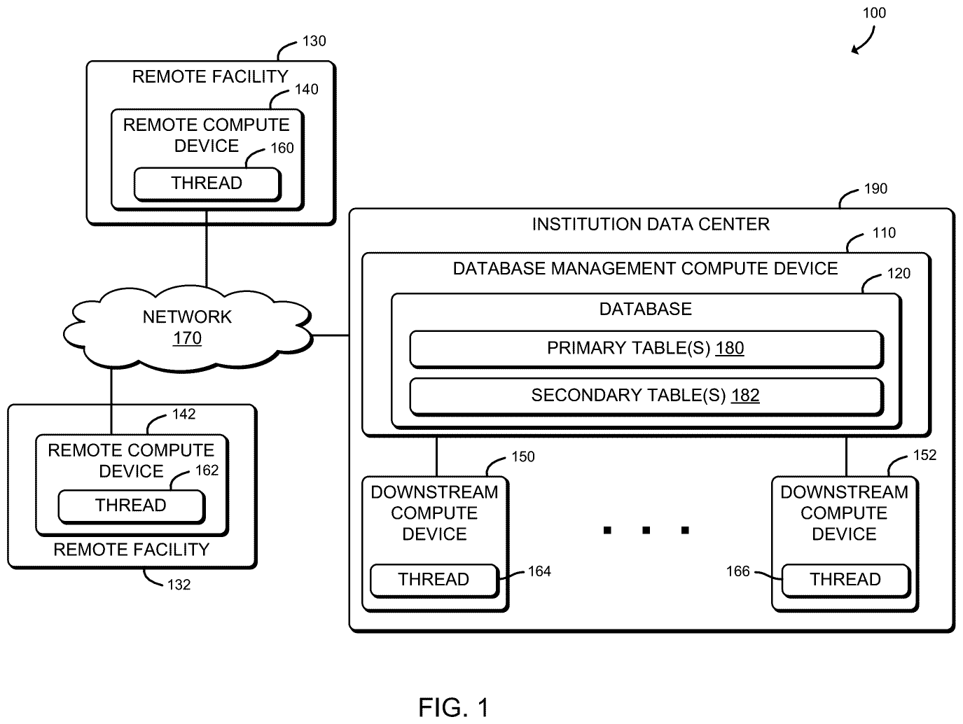

Referring now to FIG. 1, a system 100 for managing data duplication in a multithreaded environment includes, in the illustrative embodiment, a database management compute device 110 in an institution data center (e.g., a data center housing compute devices operating on behalf of an institution, such as a financial institution) communicatively connected to remote compute devices 140, 142 located in corresponding remote facilities 130, 132 (e.g., branch offices of a financial institution, etc.) and downstream compute devices 150, 152. In the illustrative embodiment, the database management compute device 110 receives, from other compute devices 140, 142, 150, 152 requests to write data to and/or read data from a database 120 in the execution of corresponding threads 160, 162, 164, 166 (e.g., tasks defined by computer-executable instructions). In the illustrative embodiment, the database 120 includes at least one primary table 180 and at least one secondary table 182.

In operation, the database management compute device 110 writes, in response to corresponding write requests, data to a secondary table 182 designated to contain temporary data (e.g., records) for a predefined period of time, such as 24 hours. In doing so, the database management compute device identifies situations in which data pertaining to the same property of a given entity (e.g., a mailing address of a given customer) is the subject of multiple concurrent write requests (e.g., from different threads 160, 162 executed by separate compute devices 140, 142) and performs a corrective action to prevent conflicts or duplicates from resulting. Subsequently, the database management compute device writes the data (e.g., records) to a corresponding primary table 180. As a result, and as compared to typical systems in which near simultaneous updates to a given set of data may result in two active records (e.g., because neither update reflects the other update as a previous update), the system 100, and more specifically the database management compute device 110, reduces the likelihood that duplication or conflicting data is added to database table(s) (e.g., the primary table(s) 180) relied on by multiple downstream compute devices 150, 152 that may otherwise result in processing errors and/or delays.

While a single database management compute device 110, two remote compute devices 140, 142, and two downstream compute devices 150, 152 are shown for simplicity and clarity, it should be understood that the number of compute devices, in practice, may range in the tens, hundreds, thousands, or more. Likewise, it should be understood that the compute devices 110, 140, 142, 150, 152 may be distributed differently or perform different roles than the configuration shown in FIG. 1. For example, in some embodiments, one or more downstream compute devices 150, 152 may be located outside of the institution data center 190. In some embodiments, one or more compute devices 140, 142, 150, 152 may send data write requests to the database management compute device 110 and request data from the database management compute device 110. Further, though shown as separate compute devices 110, 140, 142, 150, 152 in some embodiments, the functionality of one or more of the compute devices 110, 140, 142, 150, 152 may be combined into fewer compute devices and/or distributed across more compute devices than those shown in FIG. 1.

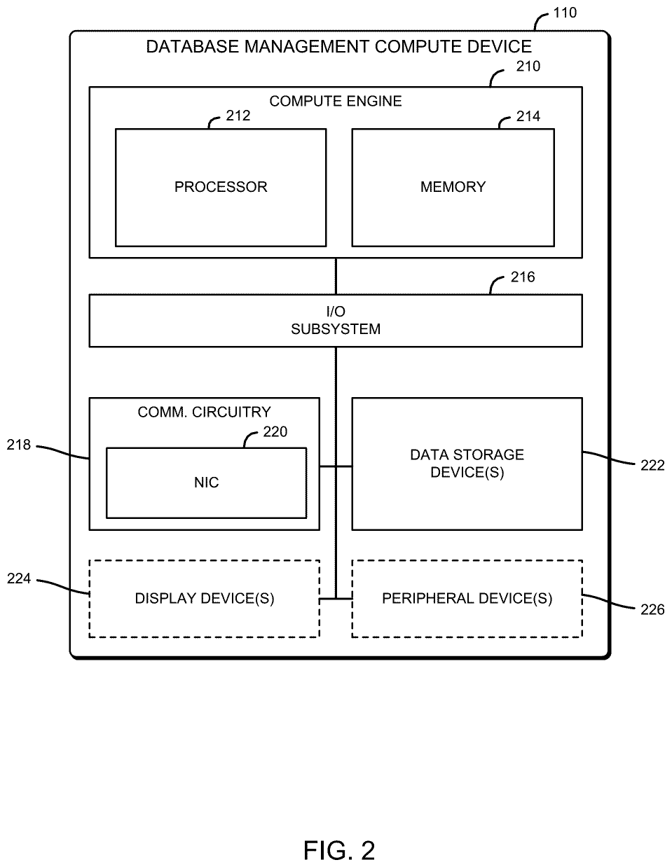

Referring now to FIG. 2, the illustrative database management compute device 110 includes a compute engine 210, an input/output (I/O) subsystem 216, communication circuitry 218, and one or more data storage devices 222. In some embodiments, the database management compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the database management compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as database records, applications, libraries, and drivers.

The compute engine 210 is communicatively coupled to other components of the database management compute device 110 via the I/O subsystem 216, which may be embodied as circuitry and/or components to facilitate input/output operations with the compute engine 210 (e.g., with the processor 212 and the main memory 214) and other components of the database management compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the database management compute device 110, into the compute engine 210.

The communication circuitry 218 may be embodied as any communication circuit, device, or collection thereof, capable of enabling communications over a network between the database management compute device 110 and another device (e.g., a compute device 140, 142, 150, 152, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the database management compute device 110 to connect with another compute device (e.g., a compute device 140, 142, 150, 152, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the error management compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the database management compute device 110 are housed in a single unit. However, in other embodiments, the components may be in separate housings, in separate racks of a data center, and/or spread across multiple data centers or other facilities. The compute devices 140, 142, 150, 152 may have components similar to those described in FIG. 2 with reference to the database management compute device 110. The description of those components of the database management compute device 110 is equally applicable to the description of components of the compute devices 140, 142, 150, 152. Further, it should be appreciated that any of the devices 140, 142, 150, 152 may include other components, sub-components, and devices commonly found in a computing device, which are not discussed above in reference to the database management compute device 110 and not discussed herein for clarity of the description.

In the illustrative embodiment, the compute devices 110, 140, 142, 150, 152 are in communication via a network 170, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

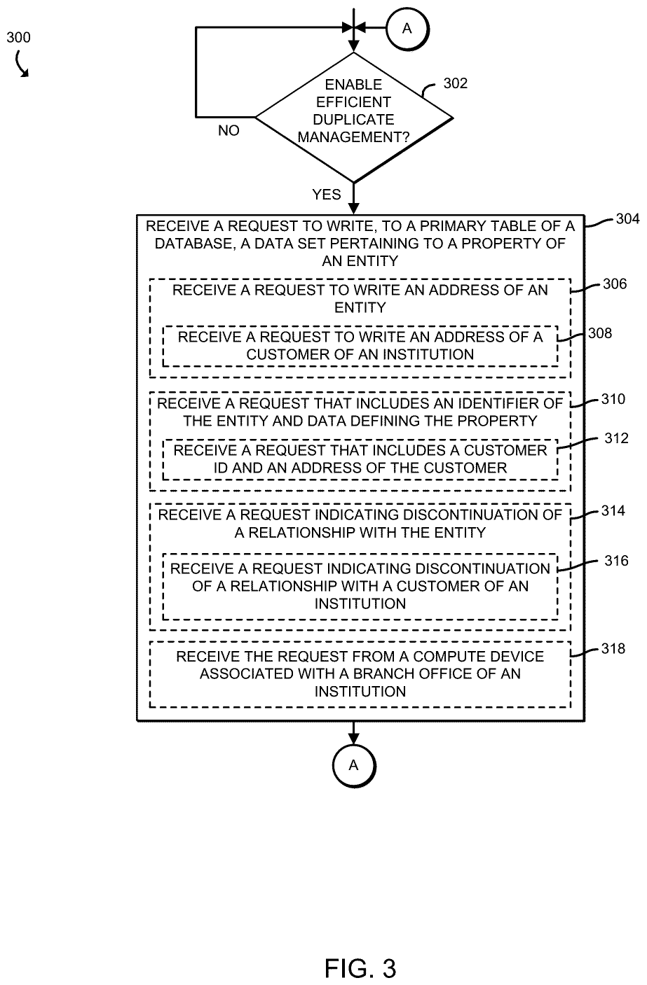

Referring now to FIG. 3, the system 100, and more specifically, the database management compute device 110, in the illustrative embodiment, may perform a method 300 for providing efficient duplicate management (e.g., management of concurrent write requests from separate thread(s) affecting the same data). The method 300 begins with block 302 in which the database management compute device 110 determines whether to enable efficient duplicate management. In doing so, the database management compute device 110 may determine to enable efficient duplicate management in response to a determination that a configuration setting (e.g., in memory 214 or in storage 222) indicates to enable efficient duplicate management, in response to receiving a request from another compute device to enable efficient duplicate management, and/or based on other factors. Regardless, in response to a determination to enable efficient duplicate management, the method 300 advances to block 304 in which the database management compute device 110 receives a request to write, to a primary table of a database, a data set pertaining to a property of an entity. As indicated in block 306, the database management compute device 110 may receive a request to write an address (e.g., a primary mailing address) of an entity.

As indicated in block 308, the database management compute device 110 may receive a request to write an address (e.g., primary mailing address) of a customer of an institution (e.g., an institution that operates the database management compute device 110, such as a financial institution). In some embodiments, the database management compute device 110 may receive a request that includes an identifier of the entity and data defining the property of the entity, as indicated in block 310. For example, and as indicated in block 312, the database management compute device 110 may receive a request that includes a customer identifier (e.g., a number or string of numeric values and/or letters that identifies a customer) and an address (e.g., primary mailing address) of the customer. In receiving a request to write to the database, the database management compute device 110 may receive a request indicating discontinuation of a relationship with the entity, as indicated in block 314. For example, and as indicated in block 316, the database management compute device 110 may receive a request that indicates discontinuation of a relationship with a customer of an institution (e.g., indicating that a particular customer has indicated that he or she would like to no longer be a customer of the financial institution). In some embodiments, and as indicated in block 318, the database management compute device 110 may receive the request from a compute device associated with a branch office of an institution (e.g., from one of the remote compute devices 140, 142 executing a corresponding thread 160, 162) of FIG. 1.

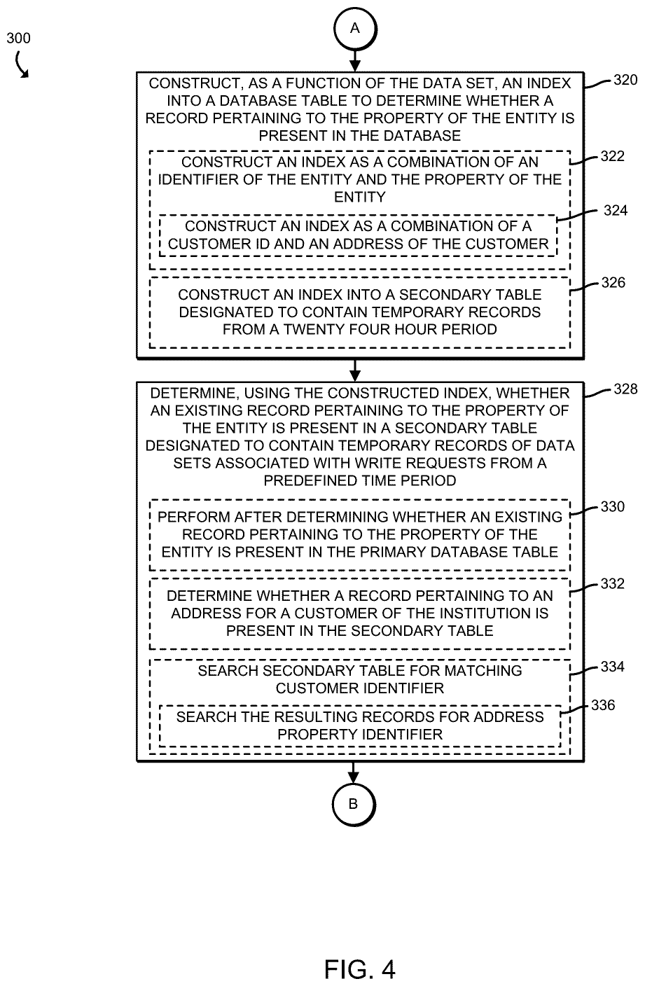

Referring now to FIG. 4, in block 320, the database management compute device 110 constructs, as a function of the data set (e.g., from block 304), an index into a database table (e.g., a database table 180, 182) to determine whether a record pertaining to the property of the entity is present in the database. In doing so, and as indicated in block 322, the database management compute device 110 may construct an index as a combination of an identifier of the entity and the property of the entity (e.g., the property that was the subject of the write request received in block 304). For example, and as indicated in block 324, the database management compute device 110 may construct an index as a combination of a customer identifier and an address (e.g., primary mailing address) of the customer. As indicated in block 326, the database management compute device 110 may construct an index into a secondary table (e.g., a secondary table 182) designated to contain temporary records for a defined time period (e.g., 24 hours).

The method 300 continues to block 328 in which the database management compute device 110 determines, using the constructed index, whether an existing record pertaining to the property of the entity is present in a secondary table 182 designated to contain temporary records of data sets associated with write requests from a predefined time period. In at least some embodiments, the database management compute device 110 does so after determining whether an existing record pertaining to the property of the entity is present in the primary database table 180, as indicated in block 330. As indicated in block 332, the database management compute device 110 may determine whether a record pertaining to an address (e.g., primary mailing address) for a customer of the institution is present in the secondary table 182. In making such a determination, the database management compute device 110 may search the secondary table for a matching customer identifier, as indicated in block 334, then search the resulting records (e.g., those having the matching customer identifier) for an address property identifier (e.g., records that affect the primary mailing address of the customer), as indicated in block 336.

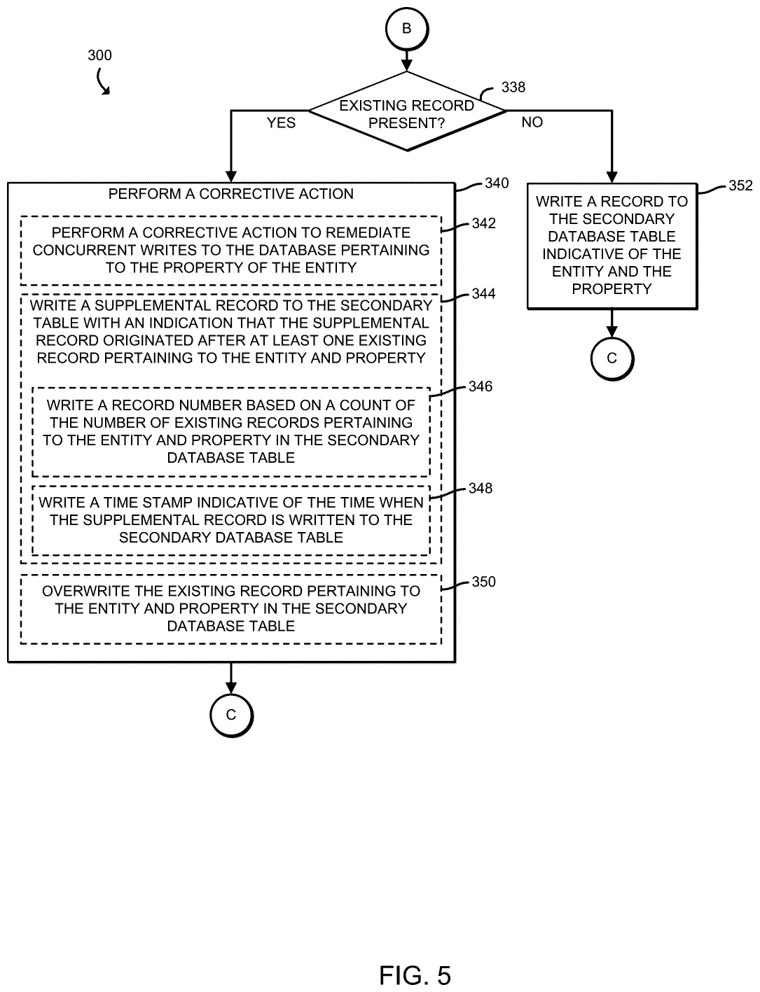

Referring now to FIG. 5, the database management compute device 110 determines a subsequent course of action based on whether an existing record pertaining to the property of the customer is present in the database (e.g., based on the determination performed in block 328). In response to a determination that an existing record is present, the database management compute device 110 performs a corrective action, as indicated in block 340. In doing so, the database management compute device 110 performs a corrective action to remediate concurrent writes to the database pertaining to the property of the entity, as indicated in block 342. As indicated in block 344, the database management compute device 110 may write a supplemental record to the secondary table 182 with an indication that the supplemental record originated after at least one existing record pertaining to the entity and the property (e.g., the primary mailing address of the customer). In doing so, the database management compute device 110 may write a record number based on a count of the number of existing records pertaining to the entity and the property (e.g., the primary mailing address) in the secondary database table 182, as indicated in block 346. That is if one record already exists in the secondary database pertaining to the customer identifier and the primary mailing address, the database management compute device 110 may write a subsequent record to the secondary table 182 with the customer identifier and the updated primary mailing address and the number 2 (or 1 for a zero-based numbering scheme) in a field (e.g., column) reserved for the sequencing of records pertaining to the same type of data (e.g., the primary mailing address for the same customer identifier). Additionally or alternatively, as indicated in block 348, the database management compute device 110 may write a time stamp indicative of the time when the supplemental record is written to the secondary database table 182 to preserve sequencing information. As indicated in block 350, in some embodiments, the database management compute device 110 may overwrite an existing record in the secondary table 182 pertaining to the property of the entity (e.g., rather than writing a supplemental record).

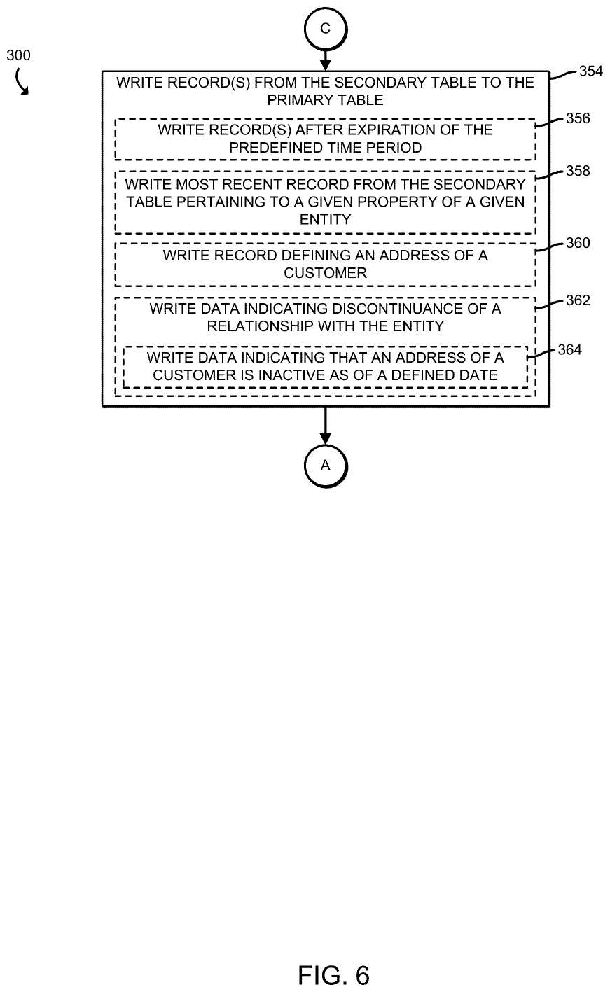

Referring back to the decision block 338, if the database management compute device 110 determines that an existing record pertaining to the entity and property of the entity is not present in the database 120, the database management compute device 110 proceeds with writing a record, to the secondary table 182, indicative of the entity and the property (e.g., the primary mailing address of the customer), as indicated in block 352. After performing the operations resulting from the determination in block 338, the method 300 subsequently proceeds to block 354 of FIG. 6, in which the database management compute device 110 writes one or more records from the secondary table 182 to the primary table 180.

Referring now to FIG. 6, and as indicated in block 356, the database management compute device 110 writes the records from the secondary table 182 after the predefined time period (e.g. 24 hours) has expired, such as in a daily batch process. In writing the record(s), and as indicated in block 358, the database management compute device 110 illustratively writes the most recent record from the secondary table 182 pertaining to a given property of a given entity (e.g., the most recent primary address of a customer, as indicated by a record number and/or timestamp written in association with each record). The database management compute device 110 writes, in the illustrative embodiment, a record defining an address (e.g., primary mailing address) associated with a customer, as indicated in block 360. In some embodiments, the database management compute device 110 writes data indicating discontinuation of a relationship with the entity, as indicated in block 362. In doing so and as indicated in block 364, the database management compute device 110 may write data indicating that an address of a customer is inactive as of a defined date (e.g., as defined in the received write request in block 314). In some embodiments, the update to indicate discontinuance of a relationship with an entity includes changing an identifier (e.g., an active identifier) from a value of “Y” to “N” to signify that the relationship has ended. Subsequently, the method 300 loops back to block 304 to potentially receive additional write requests. Though the operations are illustrated as occurring in a particular order in FIGS. 3-6, it should be understood that the operations may be performed in a different order and/or concurrently depending on the particular embodiment (e.g., receiving write requests while also writing records to the secondary table 182).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to receive a request to write, to a primary table of a database, a data set pertaining to a property of an entity; construct, as a function of the data set, an index to determine whether a record pertaining to the property of the entity is present in the database; determine, using the constructed index, whether an existing record pertaining to the property of the entity is present in a secondary table designated to contain temporary records associated with write requests from a predefined period; and perform, in response to a determination that an existing record pertaining to the property of the entity is present in the secondary table, a corrective action to remediate concurrent writes to the database pertaining to the property of the entity.

Example 2 includes the subject matter of Example 1, and wherein to determine, using the constructed index, whether a record pertaining to the property of the entity is present in the secondary table comprises to determine whether a record pertaining to the property of the entity is present in the secondary table after determining whether a record pertaining to the property of the entity is present in the primary table.

Example 3 includes the subject matter of any of Examples 1 and 2, and wherein the circuitry is further configured to write a record indicative of the property of the entity to the secondary database table.

Example 4 includes the subject matter of any of Examples 1-3, and wherein the circuitry is further configured to write one or more records from the secondary table to the primary table.

Example 5 includes the subject matter of any of Examples 1-4, and wherein to write one or more records from the secondary table to the primary table comprises to write the one or more records after expiration of the predefined time period.

Example 6 includes the subject matter of any of Examples 1-5, and wherein to receive a request to write, to a primary table of a database, a data set pertaining to a property of an entity comprises to receive a request to write an address of the entity.

Example 7 includes the subject matter of any of Examples 1-6, and wherein to receive a request to write the address of the entity comprises to receive a request to write an address of a customer of an institution.

Example 8 includes the subject matter of any of Examples 1-7, and wherein to receive a request comprises to receive a request that includes a customer identifier and an address of the customer.

Example 9 includes the subject matter of any of Examples 1-8, and wherein to receive a request comprises to receive the request from a compute device associated with a branch office of an institution.

Example 10 includes the subject matter of any of Examples 1-9, and wherein to determine, using the constructed index, whether an existing record pertaining to the property of the entity is present in a secondary table designated to contain temporary records associated with write requests from a predefined period comprises to determine whether an existing record pertaining to the property of the entity is present in a secondary table designated to contain temporary records associated with write requests from a twenty four hour period.

Example 11 includes the subject matter of any of Examples 1-10, and wherein to perform the corrective action comprises to write a supplemental record to the secondary table with an indication that the supplemental record originated after the existing record that was determined to be present in the secondary table.

Example 12 includes the subject matter of any of Examples 1-11, and wherein to write the supplemental record with an indication that the supplemental record originated after the existing record comprises to write a record number defined based on a count of existing records pertaining to the entity and property in the secondary table.

Example 13 includes the subject matter of any of Examples 1-12, and wherein to write the supplemental record with an indication that the supplemental record originated after the existing record comprises to write a time stamp indicative of when the supplemental record is written to the secondary table.

Example 14 includes the subject matter of any of Examples 1-13, and wherein to perform the corrective action comprises to overwrite the existing record in the secondary table.

Example 15 includes the subject matter of any of Examples 1-14, and wherein the circuitry is configured to receive a request indicating discontinuance of a relationship with the entity; and write, to the database, data indicating discontinuance of a relationship with the entity.

Example 16 includes the subject matter of any of Examples 1-15, and wherein to write, to the database, data indicating discontinuance of a relationship with the entity comprises to write data indicating that an address of a customer is inactive as of a defined date.

Example 17 includes a method comprising receiving, by a compute device, a request to write, to a primary table of a database, a data set pertaining to a property of an entity; constructing, by the compute device and as a function of the data set, an index to determine whether a record pertaining to the property of the entity is present in the database; determining, by the compute device and using the constructed index, whether an existing record pertaining to the property of the entity is present in a secondary table designated to contain temporary records associated with write requests from a predefined period; and performing, by the compute device and in response to a determination that an existing record pertaining to the property of the entity is present in the secondary table, a corrective action to remediate concurrent writes to the database pertaining to the property of the entity.

Example 18 includes the subject matter of Example 17, and wherein determining, using the constructed index, whether a record pertaining to the property of the entity is present in the secondary table comprises determining whether a record pertaining to the property of the entity is present in the secondary table after determining whether a record pertaining to the property of the entity is present in the primary table.

Example 19 includes the subject matter of any of Examples 17 and 18, and further including writing, by the compute device, a record indicative of the property of the entity to the secondary database table.

Example 20 includes the subject matter of any of Examples 17-19, and further including writing, by the compute device, one or more records from the secondary table to the primary table.

Example 21 includes the subject matter of any of Examples 17-20, and wherein writing one or more records from the secondary table to the primary table comprises writing the one or more records after expiration of the predefined time period.

Example 22 includes the subject matter of any of Examples 17-21, and wherein receiving a request to write, to a primary table of a database, a data set pertaining to a property of an entity comprises receiving a request to write an address of the entity.

Example 23 includes the subject matter of any of Examples 17-22, and wherein receiving a request to write the address of the entity comprises receiving a request to write an address of a customer of an institution.

Example 24 includes the subject matter of any of Examples 17-23, and wherein receiving a request comprises receiving a request that includes a customer identifier and an address of the customer.

Example 25 includes the subject matter of any of Examples 17-24, and wherein receiving a request comprises receiving the request from a compute device associated with a branch office of an institution.

Example 26 includes the subject matter of any of Examples 17-25, and wherein determining, using the constructed index, whether an existing record pertaining to the property of the entity is present in a secondary table designated to contain temporary records associated with write requests from a predefined period comprises determining whether an existing record pertaining to the property of the entity is present in a secondary table designated to contain temporary records associated with write requests from a twenty four hour period.

Example 27 includes the subject matter of any of Examples 17-26, and wherein performing the corrective action comprises writing a supplemental record to the secondary table with an indication that the supplemental record originated after the existing record that was determined to be present in the secondary table.

Example 28 includes the subject matter of any of Examples 17-27, and wherein writing the supplemental record with an indication that the supplemental record originated after the existing record comprises writing a record number defined based on a count of existing records pertaining to the entity and property in the secondary table.

Example 29 includes the subject matter of any of Examples 17-28, and wherein writing the supplemental record with an indication that the supplemental record originated after the existing record comprises writing a time stamp indicative of when the supplemental record is written to the secondary table.

Example 30 includes the subject matter of any of Examples 17-29, and wherein performing the corrective action comprises overwriting the existing record in the secondary table.

Example 31 includes the subject matter of any of Examples 17-30, and further including receiving, by the compute device, a request indicating discontinuance of a relationship with the entity; and writing, to the database, data indicating discontinuance of a relationship with the entity.

Example 32 includes the subject matter of any of Examples 17-31, and wherein writing, to the database, data indicating discontinuance of a relationship with the entity comprises writing data indicating that an address of a customer is inactive as of a defined date.

Example 33 includes one or more machine-readable storage media comprising a plurality of instructions stored thereon that, in response to being executed, cause a compute device to receive a request to write, to a primary table of a database, a data set pertaining to a property of an entity; construct, as a function of the data set, an index to determine whether a record pertaining to the property of the entity is present in the database; determine, using the constructed index, whether an existing record pertaining to the property of the entity is present in a secondary table designated to contain temporary records associated with write requests from a predefined period; and perform, in response to a determination that an existing record pertaining to the property of the entity is present in the secondary table, a corrective action to remediate concurrent writes to the database pertaining to the property of the entity.

Example 34 includes the subject matter of Example 33, and wherein to determine, using the constructed index, whether a record pertaining to the property of the entity is present in the secondary table comprises to determine whether a record pertaining to the property of the entity is present in the secondary table after determining whether a record pertaining to the property of the entity is present in the primary table.

Example 35 includes the subject matter of any of Examples 33 and 34, and wherein the instructions additionally cause the compute device to write a record indicative of the property of the entity to the secondary database table.

Example 36 includes the subject matter of any of Examples 33-35, and wherein the instructions additionally cause the compute device to write one or more records from the secondary table to the primary table.

Example 37 includes the subject matter of any of Examples 33-36, and wherein to write one or more records from the secondary table to the primary table comprises to write the one or more records after expiration of the predefined time period.

Example 38 includes the subject matter of any of Examples 33-37, and wherein to receive a request to write, to a primary table of a database, a data set pertaining to a property of an entity comprises to receive a request to write an address of the entity.

Example 39 includes the subject matter of any of Examples 33-38, and wherein to receive a request to write the address of the entity comprises to receive a request to write an address of a customer of an institution.

Example 40 includes the subject matter of any of Examples 33-39, and wherein to receive a request comprises to receive a request that includes a customer identifier and an address of the customer.

Example 41 includes the subject matter of any of Examples 33-40, and wherein to receive a request comprises to receive the request from a compute device associated with a branch office of an institution.

Example 42 includes the subject matter of any of Examples 33-41, and wherein to determine, using the constructed index, whether an existing record pertaining to the property of the entity is present in a secondary table designated to contain temporary records associated with write requests from a predefined period comprises to determine whether an existing record pertaining to the property of the entity is present in a secondary table designated to contain temporary records associated with write requests from a twenty four hour period.

Example 43 includes the subject matter of any of Examples 33-42, and wherein to perform the corrective action comprises to write a supplemental record to the secondary table with an indication that the supplemental record originated after the existing record that was determined to be present in the secondary table.

Example 44 includes the subject matter of any of Examples 33-43, and wherein to write the supplemental record with an indication that the supplemental record originated after the existing record comprises to write a record number defined based on a count of existing records pertaining to the entity and property in the secondary table.

Example 45 includes the subject matter of any of Examples 33-44, and wherein to write the supplemental record with an indication that the supplemental record originated after the existing record comprises to write a time stamp indicative of when the supplemental record is written to the secondary table.

Example 46 includes the subject matter of any of Examples 33-45, and wherein to perform the corrective action comprises to overwrite the existing record in the secondary table.

Example 47 includes the subject matter of any of Examples 33-46, and wherein the instructions additionally cause the compute device to receive a request indicating discontinuance of a relationship with the entity; and write, to the database, data indicating discontinuance of a relationship with the entity.

Example 48 includes the subject matter of any of Examples 33-47, and wherein to write, to the database, data indicating discontinuance of a relationship with the entity comprises to write data indicating that an address of a customer is inactive as of a defined date.

1. A compute device comprising:
circuitry configured to:
receive a request to write, to a primary table of a database, a data set pertaining to a property of an entity;
construct, as a function of the data set, an index to determine whether a record pertaining to the property of the entity is present in the database;
determine, using the constructed index, whether an existing record pertaining to the property of the entity is present in a secondary table designated to contain temporary records associated with write requests from a predefined period; and
perform, in response to a determination that an existing record pertaining to the property of the entity is present in the secondary table, a corrective action to remediate concurrent writes to the database pertaining to the property of the entity.

2. The compute device of claim 1, wherein to determine, using the constructed index, whether a record pertaining to the property of the entity is present in the secondary table comprises to determine whether a record pertaining to the property of the entity is present in the secondary table after determining whether a record pertaining to the property of the entity is present in the primary table.

3. The compute device of claim 1, wherein the circuitry is further configured to write a record indicative of the property of the entity to the secondary database table.

4. The compute device of claim 1, wherein the circuitry is further configured to write one or more records from the secondary table to the primary table after expiration of the predefined time period.

5. The compute device of claim 1, wherein to determine, using the constructed index, whether an existing record pertaining to the property of the entity is present in a secondary table designated to contain temporary records associated with write requests from a predefined period comprises to determine whether an existing record pertaining to the property of the entity is present in a secondary table designated to contain temporary records associated with write requests from a twenty four hour period.

6. The compute device of claim 1, wherein to perform the corrective action comprises to write a supplemental record to the secondary table with an indication that the supplemental record originated after the existing record that was determined to be present in the secondary table.

7. The compute device of claim 6, wherein to write the supplemental record with an indication that the supplemental record originated after the existing record comprises to write one or more of: (i) a record number defined based on a count of existing records pertaining to the entity and property in the secondary table; and/or (ii) a time stamp indicative of when the supplemental record is written to the secondary table.

8. The compute device of claim 1, wherein the circuitry is configured to:
receive a request indicating discontinuance of a relationship with the entity; and
write, to the database, data indicating discontinuance of a relationship with the entity.

9. The compute device of claim 8, wherein to write, to the database, data indicating discontinuance of a relationship with the entity comprises to write data indicating that an address of a customer is inactive as of a defined date.

10. A method comprising:
receiving, by a compute device, a request to write, to a primary table of a database, a data set pertaining to a property of an entity;
constructing, by the compute device and as a function of the data set, an index to determine whether a record pertaining to the property of the entity is present in the database;
determining, by the compute device and using the constructed index, whether an existing record pertaining to the property of the entity is present in a secondary table designated to contain temporary records associated with write requests from a predefined period; and
performing, by the compute device and in response to a determination that an existing record pertaining to the property of the entity is present in the secondary table, a corrective action to remediate concurrent writes to the database pertaining to the property of the entity.

11. The method of claim 10, wherein determining, using the constructed index, whether a record pertaining to the property of the entity is present in the secondary table comprises determining whether a record pertaining to the property of the entity is present in the secondary table after determining whether a record pertaining to the property of the entity is present in the primary table.

12. The method of claim 10, further comprising writing, by the compute device, a record indicative of the property of the entity to the secondary database table.

13. The method of claim 10, further comprising writing, by the compute device, one or more records from the secondary table to the primary table after expiration of the predefined time period.

14. The method of claim 10, wherein determining, using the constructed index, whether an existing record pertaining to the property of the entity is present in a secondary table designated to contain temporary records associated with write requests from a predefined period comprises determining whether an existing record pertaining to the property of the entity is present in a secondary table designated to contain temporary records associated with write requests from a twenty four hour period.

15. The method of claim 10, wherein performing the corrective action comprises writing a supplemental record to the secondary table with an indication that the supplemental record originated after the existing record that was determined to be present in the secondary table.

16. The method of claim 15, wherein writing the supplemental record with an indication that the supplemental record originated after the existing record comprises writing one or more of: (i) a record number defined based on a count of existing records pertaining to the entity and property in the secondary table; and/or (ii) a time stamp indicative of when the supplemental record is written to the secondary table.

17. The method of claim 10, further comprising:
receiving, by the compute device, a request indicating discontinuance of a relationship with the entity; and
writing, to the database, data indicating discontinuance of a relationship with the entity.

18. The method of claim 17, wherein writing, to the database, data indicating discontinuance of a relationship with the entity comprises writing data indicating that an address of a customer is inactive as of a defined date.

19. One or more machine-readable storage media comprising a plurality of instructions stored thereon that, in response to being executed, cause a compute device to:
receive a request to write, to a primary table of a database, a data set pertaining to a property of an entity;
construct, as a function of the data set, an index to determine whether a record pertaining to the property of the entity is present in the database;
determine, using the constructed index, whether an existing record pertaining to the property of the entity is present in a secondary table designated to contain temporary records associated with write requests from a predefined period; and
perform, in response to a determination that an existing record pertaining to the property of the entity is present in the secondary table, a corrective action to remediate concurrent writes to the database pertaining to the property of the entity.

20. The one or more machine-readable storage media of claim 19, wherein to determine, using the constructed index, whether a record pertaining to the property of the entity is present in the secondary table comprises to determine whether a record pertaining to the property of the entity is present in the secondary table after determining whether a record pertaining to the property of the entity is present in the primary table.
